(19) United States
(12) Patent Application Publication
(10) Pub. No.: US 2017/0177255 A1
(43) Pub. Date: Jun. 22, 2017

(54) METHOD AND ELECTRONIC DEVICE FOR ALLOCATING DYNAMIC MEMORY RESOURCES

(71) Applicants: Le Holdings (Beijing) Co., Ltd., Beijing (CN); Lemobile Information Technology (Beijing) Co., Ltd ., Beijing (CN)

(72) Inventor: Guofeng Xie, Beijing (CN)

(73) Assignees: Le Holdings (Beijing) Co., Ltd., Beijing (CN); Lemobile Information Technology (Beijing) Co., Ltd ., Beijing (CN)

(21) Appl. No.: 15/242,720

(22) Filed: Aug. 22, 2016

Related U.S. Application Data
(63) Continuation of application No. PCT/CN2016/088545, filed on Jul. 5, 2016.

(30) Foreign Application Priority Data
Dec. 17, 2015 (CN) 201510954679.2

(51) Int. Cl. G06F 3/06; G06F 12/02; H04W 52/02

(52) U.S. Cl. CPC G06F 3/0625; H04W 52/028; G06F 3/0631; G06F 3/0673; G06F 12/023; G06F 2212/1028; G06F 2212/253

(57) ABSTRACT

This disclosure discloses a method and electronic device for allocating dynamic memory resources, wherein the method includes the following steps: acquiring a memory resource allocation request of an application; judging whether a condition that the bandwidth of the dynamic memory to be allocated is restricted to partial bandwidth is met or not; and if the condition is met, then allocating partial bandwidth of the dynamic memory according to the memory resource allocation request; or otherwise, allocating all the bandwidth of the dynamic memory to the application. The method and device disclosed by this disclosure allocate memory resources according to needs of a terminal device, so that not only the performance of a smart mobile terminal is guaranteed, but also the battery life of the smart mobile terminal is prolonged by avoiding the resource waste to save power consumption.

### CROSS REFERENCE TO RELATED APPLICATIONS

This disclosure is a continuation of International Application No. PCT/CN2016/088545 filed on Jul. 05, 2016, which is based upon and claims priority to Chinese Patent Application No. 201510954679.2, filed on Dec. 17, 2015, titled “METHOD AND DEVICE FOR ALLOCATING DYNAMIC MEMORY RESOURCES”, and the entire contents of which are incorporated herein by reference.

### TECHNICAL FIELD

This disclosure relates to the technical field of smart mobile terminals, and specifically relates to a method and electronic device for allocating dynamic memory resources.

### BACKGROUND

At present, a smart phone has increasingly stronger performance, but the endurance time of mobile phone has always been a pain point of user experience, and the majority of users' criticisms on smart phones lie in this. Before revolutionary improvement of the battery technology, the endurance time of a battery is indirectly prolonged by optimizing system resources, and reducing occupation of resources by a system. Where, resource allocation based on needs, namely saving some unnecessary resource consumption, can save energy. For example, CPC may dynamically adjust the frequency and the number of CPUs through system loads. A GPU (graphics processing unit) and other resources may also be allocated as needed.

However, the existing system resource optimization methods do not optimize all the resources very comprehensively, so that the improvement of the endurance time is also very limited.

A DRAM, namely a dynamic random access memory, is the most common system memory. The DRAM can only retain data for a very short time. In order to retain data, the DRAM uses a capacitor memory, so that the DRAM must be refreshed at set intervals, and if a memory cell is not refreshed, the stored information will be lost.

### SUMMARY

This disclosure discloses a method and electronic device for allocating dynamic memory resources, to solve the problem that the method for prolonging the endurance time by optimizing system resources in the existing smart mobile terminal is not perfect, thereby prolonging the endurance time of the smart mobile terminal.

Thus, the embodiments of this disclosure provide the following technical solutions:

One objective of the embodiments of this disclosure is to provide a method for allocating dynamic memory resources, including the following steps: acquiring a memory resource allocation request of an application; judging whether a condition that the bandwidth of the dynamic memory to be allocated is restricted to partial bandwidth is met or not; and if the condition is met, then allocating partial bandwidth of the dynamic memory according to the memory resource allocation request; or otherwise, allocating all the bandwidth of the dynamic memory to the application.

Preferably, the step of judging whether the condition that the bandwidth of the dynamic memory to be allocated is restricted to partial bandwidth is met or not includes: judging whether a memory resource allocation request for all the bandwidth of the dynamic memory exists or not; and if the memory resource allocation request exists, then determining that the condition is not met; or otherwise, determining that the condition is met.

Preferably, the step of judging whether the condition that the bandwidth of the dynamic memory to be allocated is restricted to partial bandwidth is met or not includes: judging whether a screen of the mobile device is in a screen-off state or not; and if the screen is in the screen-off state, then determining that the condition is met; or otherwise, judging whether the number of CPU is less than 2 or not; and if the number of CPU is less than 2, then determining that the condition is not met.

Preferably, the step of judging whether the condition that the bandwidth of the dynamic memory to be allocated is restricted to partial bandwidth is met or not also includes: judging whether a memory resource allocation request for all the bandwidth of the dynamic memory exists or not if the number of CPU is more than 2; and if the memory resource allocation request exists, then determining that the condition is not met; or otherwise, determining that the condition is met.

Preferably, when the screen is in the screen-off state, the bandwidth of the dynamic memory to be allocated is restricted to one fourth.

Preferably, the step of judging whether the condition that the bandwidth of the dynamic memory to be allocated is restricted to partial bandwidth is met or not includes: judging whether an instruction to light up the screen exists or not when the screen of the mobile device is in the screen-off state; and if the instruction exists, then determining that the condition is not met.

Preferably, the step of judging whether the condition that the bandwidth of the dynamic memory to be allocated is restricted to partial bandwidth is met or not includes: judging whether startup of an operating system of the mobile device is started or not; and if startup of the operating system of the mobile device is started, then determining that the condition is not met.

Preferably, the step of judging whether the condition that the bandwidth of the dynamic memory to be allocated is restricted to partial bandwidth is met or not includes: judging whether startup of the operating system of the mobile device is completed or not; if startup of the operating system of the mobile device is completed, then judging whether a memory resource allocation request for all the bandwidth of the dynamic memory exists or not; and if the memory resource allocation request exists, then determining that the condition is not met; or otherwise, determining that the condition is met.

Preferably, the step of judging whether the condition that the bandwidth of the dynamic memory to be allocated is restricted to partial bandwidth is met or not includes: judging whether startup of the operating system of the mobile device is completed or not; if startup of the operating system of the mobile device is completed, then judging whether a screen of the mobile device is in a screen-off state or not; if the screen of the mobile device is in the screen-off state, then determining that the condition is met; or otherwise, judging whether the number of CPU is less than 2 or not; if the number of CPU is less than 2, then determining that the condition is not met; or if the number of CPU is more than 2, judging whether a memory resource allocation request for all the bandwidth of the dynamic memory exists or not; and if the memory resource allocation request exists, then determining that the condition is not met; or otherwise, determining that the condition is met.

Another objective of the embodiments of this disclosure is to provide an electronic device, including at least one processor, and a memory in communication connection with the at least one processor, where the memory stores instructions that can be executed by the at least one processor, and the instructions are executed by the at least one processor to enable the at least one processor to: acquire a memory resource allocation request of an application; judge whether a condition that the bandwidth of the dynamic memory to be allocated is restricted to partial bandwidth is met or not; and allocate partial bandwidth of the dynamic memory according to the memory resource allocation request if the condition is met; or allocate all the bandwidth of the dynamic memory to the application if the condition is not met.

Where, the step of judging whether the condition that the bandwidth of the dynamic memory to be allocated is restricted to partial bandwidth is met or not includes: judging whether a memory resource allocation request for all the bandwidth of the dynamic memory exists or not, and if the memory resource allocation request exists, then determining that the condition is not met; or otherwise, determining that the condition is met.

Where, the step of judging whether the condition that the bandwidth of the dynamic memory to be allocated is restricted to partial bandwidth is met or not includes: judging whether a screen of the mobile device is in a screen-off state or not; if the screen is in the screen-off state, determining that the condition is met; or otherwise judging whether the number of CPU is less than 2 or not; and if the number of CPU is less than 2, then determining that the condition is not met.

Where, the step of judging whether the condition that the bandwidth of the dynamic memory to be allocated is restricted to partial bandwidth is met or not also includes: judging whether a memory resource allocation request for all the bandwidth of the dynamic memory exists or not if the number of CPU is more than 2; and if the memory resource allocation request exists, then determining that the condition is not met; or otherwise, determining that the condition is met.

Where, when the screen is in the screen-off state, the bandwidth of the dynamic memory to be allocated is restricted to one fourth.

Where, the step of judging whether the condition that the bandwidth of the dynamic memory to be allocated is restricted to partial bandwidth is met or not includes: judging whether an instruction to light up the screen exists or not when the screen of the mobile device is in the screen-off state; and if the instruction exists, then determining that the condition is not met.

Where, the step of judging whether the condition that the bandwidth of the dynamic memory to be allocated is restricted to partial bandwidth is met or not includes: judging whether startup of an operating system of the mobile device is started or not; and if startup of the operating system of the mobile device is started, then determining that the condition is not met.

Where, the step of judging whether the condition that the bandwidth of the dynamic memory to be allocated is restricted to partial bandwidth is met or not includes: judging whether startup of the operating system of the mobile device is completed or not; if startup of the operating system of the mobile device is completed, judging whether a memory resource allocation request for all the bandwidth of the dynamic memory exists or not; and if the memory resource allocation request exists, then determining that the condition is not met; or otherwise, determining that the condition is met.

Where, the step of judging whether the condition that the bandwidth of the dynamic memory to be allocated is restricted to partial bandwidth is met or not includes: judging whether startup of the operating system of the mobile device is completed or not; if startup of the operating system of the mobile device is completed, then judging whether a screen of the mobile device is in a screen-off state or not; if the screen of the mobile device is in the screen-off state, then determining that the condition is met; or otherwise, judging whether the number of CPU is less than 2 or not; if the number of CPU is less than 2, then determining that the condition is not met; or if the number of CPU is more than 2, then judging whether a memory resource allocation request for all the bandwidth of the dynamic memory exists or not; and if the memory resource allocation request exists, then determining that the condition is not met; or otherwise, determining that the condition is met.

Another objective of the embodiments of this disclosure is to provide a non-volatile computer storage medium storing computer executable instructions that, when executed by the electronic device, enable the electronic device to: acquire a memory resource allocation request of an application; judge whether a condition that the bandwidth of the dynamic memory to be allocated is restricted to partial bandwidth is met or not; and if the condition is met, then allocate partial bandwidth of the dynamic memory according to the memory resource allocation request; or otherwise, allocate all the bandwidth of the dynamic memory to the application.

Where, the step of judging whether the condition that the bandwidth of the dynamic memory to be allocated is restricted to partial bandwidth is met or not includes: judging whether a memory resource allocation request for all the bandwidth of the dynamic memory exists or not, and if the memory resource allocation request exists, then determining that the condition is not met; or otherwise, determining that the condition is met.

Where, the step of judging whether the condition that the bandwidth of the dynamic memory to be allocated is restricted to partial bandwidth is met or not includes: judging whether a screen of the mobile device is in a screen-off state or not; if the screen is in the screen-off state, then determining that the condition is met; or otherwise, judging whether the number of CPU is less than 2 or not; and if the number of CPU is less than 2, then determining that the condition is not met.

Where, the step of judging whether the condition that the bandwidth of the dynamic memory to be allocated is restricted to partial bandwidth is met or not also includes: judging whether a memory resource allocation request for all the bandwidth of the dynamic memory exists or not if the number of CPU is more than 2; and if the memory resource allocation request exists, then determining that the condition is not met; or otherwise, determining that the condition is met.

Where, when the screen is in the screen-off state, the bandwidth of the dynamic memory to be allocated is restricted to one fourth.

Where, the step of judging whether the condition that the bandwidth of the dynamic memory to be allocated is restricted to partial bandwidth is met or not includes: judging whether an instruction to light up the screen exists or not when the screen of the mobile device is in the screen-off state; and if the instruction exists, then determining that the condition is not met.

Where, the step of judging whether the condition that the bandwidth of the dynamic memory to be allocated is restricted to partial bandwidth is met or not includes: judging whether startup of an operating system of the mobile device is started or not; and if startup of the operating system of the mobile device is started, then determining that the condition is not met.

Where, the step of judging whether the condition that the bandwidth of the dynamic memory to be allocated is restricted to partial bandwidth is met or not includes: judging whether startup of the operating system of the mobile device is completed or not; if startup of the operating system of the mobile device is completed, then judging whether a memory resource allocation request for all the bandwidth of the dynamic memory exists or not; and if the memory resource allocation request exists, then determining that the condition is not met; or otherwise, determining that the condition is met.

Where, the step of judging whether the condition that the bandwidth of the dynamic memory to be allocated is restricted to partial bandwidth is met or not includes: judging whether startup of the operating system of the mobile device is completed or not; if startup of the operating system of the mobile device is completed, then judging whether a screen of the mobile device is in a screen-off state or not; if the screen of the mobile device is in the screen-off state, then determining that the condition is met; or otherwise, judging whether the number of CPU is less than 2 or not; if the number of CPU is less than 2, then determining that the condition is not met; or if the number of CPU is more than 2, then judging whether a memory resource allocation request for all the bandwidth of the dynamic memory exists or not; and if the memory resource allocation request exists, then determining that the condition is not met; or otherwise, determining that the condition is met.

The embodiments of this disclosure has the following advantages:

A method and electronic device for allocating dynamic memory resources, provided by the embodiments of this disclosure, allocate the memory resources according to the needs of a terminal device; and allocate all the bandwidth if the terminal device needs to allocate all the bandwidth, or otherwise may allocate only a part of the bandwidth therein without occupying the remaining bandwidth resources. That is to say, the resources are saved only when the system does not need all the memory resources, so that not only the performance of a smart mobile terminal can be guaranteed, but also the endurance time of the smart mobile terminal can be prolonged. Together with other resource optimization and allocation methods, the method and device herein can greatly improve the power saving effect, thereby further prolonging the endurance time of a smart mobile device terminal

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of a method for allocating dynamic memory resources in accordance with Embodiment 1 of this disclosure;

FIG. 2 is a flow diagram of a method for judging whether a condition that the bandwidth of the dynamic memory to be allocated is restricted to partial bandwidth is met or not

in accordance with Embodiment 1 of this disclosure;

FIG. 3 is a functional block diagram of an electronic device for allocating dynamic memory resources in accordance with Embodiment 2 of this disclosure; and

FIG. 4 is a schematic diagram of a hardware structure of the electronic device provided by the embodiments of this disclosure.

### DETAILED DESCRIPTION

To make the objectives, the technical scheme and the advantages of the embodiments of this disclosure clearer, hereinafter, the technical scheme of this disclosure is clearly and completely described through implementation with reference to the accompanying drawings in the embodiments of this disclosure, and obviously, the described embodiments are part of the embodiments of this disclosure rather than all the embodiments.

### Embodiment 1

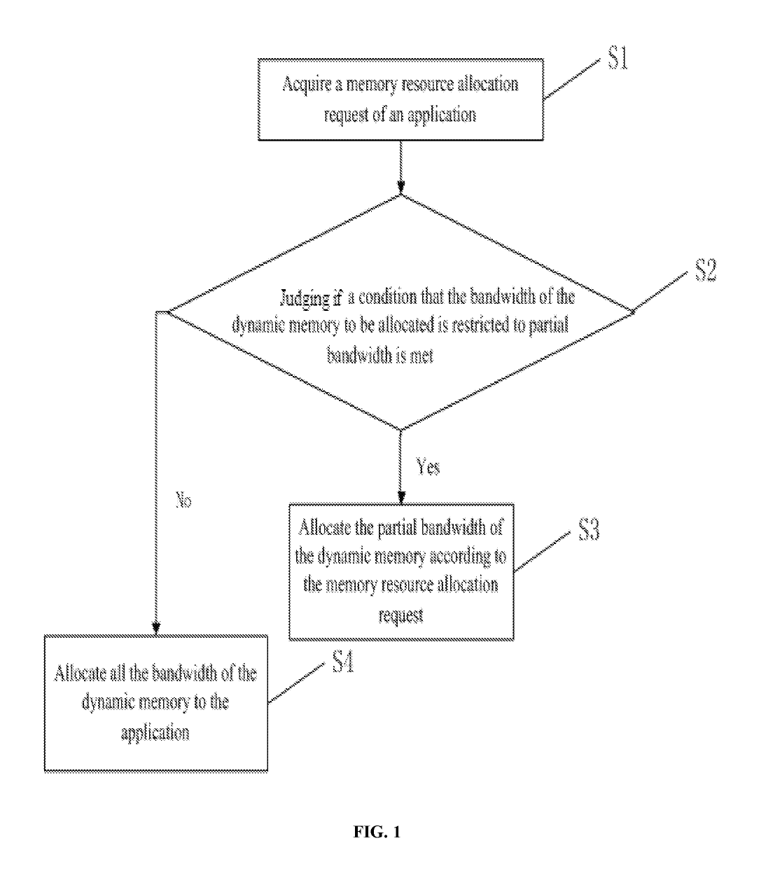

The present embodiment provides a method for allocating dynamic memory resources, and as shown in FIG. 1, the method includes the following steps:

S1: acquiring a memory resource allocation request of an application. Every application needs a memory resource after startup no matter for foreground running or background running, therefore, the application needs to request for memory resource allocation.

S2: judging whether a condition that the bandwidth of the dynamic memory to be allocated is restricted to partial bandwidth is met or not, where, the memory bandwidth refers to a data transmission speed per second between a memory and a north bridge, and the higher the better.

S3: if the condition is met, allocating partial bandwidth of the dynamic memory according to the memory resource allocation request, which may specifically include one half of the bandwidth, one fourth of the bandwidth or other ratio of the bandwidth. Or

S4: otherwise, allocating all the bandwidth of the dynamic memory to the application.

Because the memory sources of the existing smart mobile terminal are very strong, for example, the dynamic random access memory (DRAM) resources of a smart phone have reached 3 GB or even more. In a lot of use scenarios of the mobile terminal, all the memory resources are not needed while the occupation of the memory resources is in direct proportion to power consumption, and therefore, the power consumption can be saved by avoiding resource waste. A method for allocating dynamic memory resources provided by the present embodiment allocates the memory resources according to the needs of a terminal device; and allocates all the bandwidth if the terminal device needs to allocate all the bandwidth, or otherwise may allocate only a part of the bandwidth therein without occupying the remaining bandwidth resources. That is to say, the resources are saved only when the system does not need all the memory resources, so that not only the performance of a smart mobile terminal can be guaranteed, but also the endurance time of the smart mobile terminal can be prolonged. Together with other resource optimization and allocation methods, the method and the device herein can greatly improve the power saving effect, thereby further prolonging the endurance time of a smart mobile device terminal

Specifically, the step S2, namely the step of judging whether the condition that the bandwidth of the dynamic memory to be allocated is restricted to partial bandwidth is met or not, includes:
judging whether a memory resource allocation request for all the bandwidth of the dynamic memory exists or not;
and if the memory resource allocation request exists, then determining that the condition is not met;
or otherwise, determining that the condition is met.

In the present embodiment, the condition that the bandwidth of the dynamic memory to be allocated is restricted to partial bandwidth is that the bandwidth of the dynamic memory to be allocated is restricted to partial bandwidth only when all the memory resource allocation requests only request part of the bandwidth, otherwise, the bandwidth to be allocated is not restricted as long as one memory resource allocation request applies for all the bandwidth, so as to guarantee the performance of the smart mobile terminal, and promote the user experience.

Specifically, one unique identifier is allocated to each of the applications which request for allocation of memory resources, for example, the identifier may be a unique corresponding number. After each application sends a memory resource allocation request, a processing program inserts a number corresponding to an application into a linked list, and specifically, may also successively insert the numbers of various applications into the linked list in descending order by priority of the applications. Then, the linked list may be scanned, and the memory resources may be successively allocated in proper order. However, if there is a memory resource allocation request for all the bandwidth, the processing program will insert the number corresponding to the request into the header of the linked list, first scan the header of the linked list, and cancel the restriction on the memory bandwidth to be allocated. After resource allocation is completed, the processing program will delete the corresponding numbers on the linked list, receive new requests, and place the numbers corresponding to the new requests into the linked list.

As a first variant form of the present embodiment, the abovementioned step S2, namely the step of judging whether a condition that the bandwidth of the dynamic memory to be allocated is restricted to partial bandwidth is met or not, includes:
judging whether a screen of the mobile device is in a screen-off state or not;
if the screen of the mobile device is in the screen-off state, then determining that the condition is met. Specifically, it is tacitly approved under the circumstance that none of the memory resource allocation requests requests all the bandwidth, and none of the applications is in a foreground running state. Therefore, the bandwidth of the dynamic memory to be allocated may be restricted to one fourth, so as to save resources and reduce energy consumption to the maximum extent, and guarantee normal operation of each application of the mobile terminal in the screen-off state;
or otherwise, judging whether the number of CPU is less than 2 or not, and if the number of CPU is less than 2, determining that the condition is not met, that is to say, the bandwidth of the dynamic memory to be allocated cannot be restricted at that moment.

Moreover, the abovementioned step S2 also includes:
judging whether a memory resource allocation request for all the bandwidth of the dynamic memory exists or not if the number of CPU is more than 2;
and if the memory resource allocation request exists, then determining that the condition is not met;
or otherwise, determining that the condition is met.

As a second variant form of the present embodiment, the abovementioned step S2, namely the step of judging whether a condition that the bandwidth of the dynamic memory to be allocated is restricted to partial bandwidth is met or not, includes:
when the screen of the mobile device is in the screen-off state, judging whether an instruction to light up the screen exists or not, i.e., whether a screen lightening button is pressed down or not; and
if the instruction to light up the screen exists, then determining that the condition is not met.

In the present embodiment, in the process of lighting up the screen, in order to increase the speed of lighting up the screen, the bandwidth of the dynamic memory to be allocated is not restricted.

As a third variant form of the present embodiment, the abovementioned step S2, namely the step of judging whether a condition that the bandwidth of the dynamic memory to be allocated is restricted to partial bandwidth is met or not, includes:
judging whether startup of the operating system of the mobile device is started or not;
and if startup of the operating system of the mobile device is started, then determining that the condition is not met.

In the present embodiment, when the operating system of the mobile device is started, essentially all the bandwidth of the dynamic memory is not necessary, but in order to increase the starting speed of the operating system, the bandwidth of the dynamic memory to be allocated is not restricted.

As a fourth variant form of the present embodiment, the abovementioned step S2, namely the step of judging whether a condition that the bandwidth of the dynamic memory to be allocated is restricted to partial bandwidth is met or not, includes:
judging whether startup of the operating system of the mobile device is completed or not;
if startup of the operating system of the mobile device is completed, then judging whether a memory resource allocation request for all the bandwidth of the dynamic memory exists or not; and
if the memory resource allocation request exists, then determining that the condition is not met; or
otherwise, determining that the condition is met.

In the present embodiment, there are two methods for judging whether startup of the operating system of the mobile device is completed or not: one method is acquiring a startup completion instruction of the operating system of the mobile device; and the other one is judging whether the time interval between the current time and the time when startup of the operating system of the mobile device is started is greater than a preset threshold or not, and determining that startup is completed if the time interval is greater than the preset threshold, or otherwise, prolonging the preset time, and then judging whether the time interval is greater than the preset threshold or not again, where the preset threshold is determined by collecting the startup time of the mobile device, and may be generally set to be greater than a general startup time.

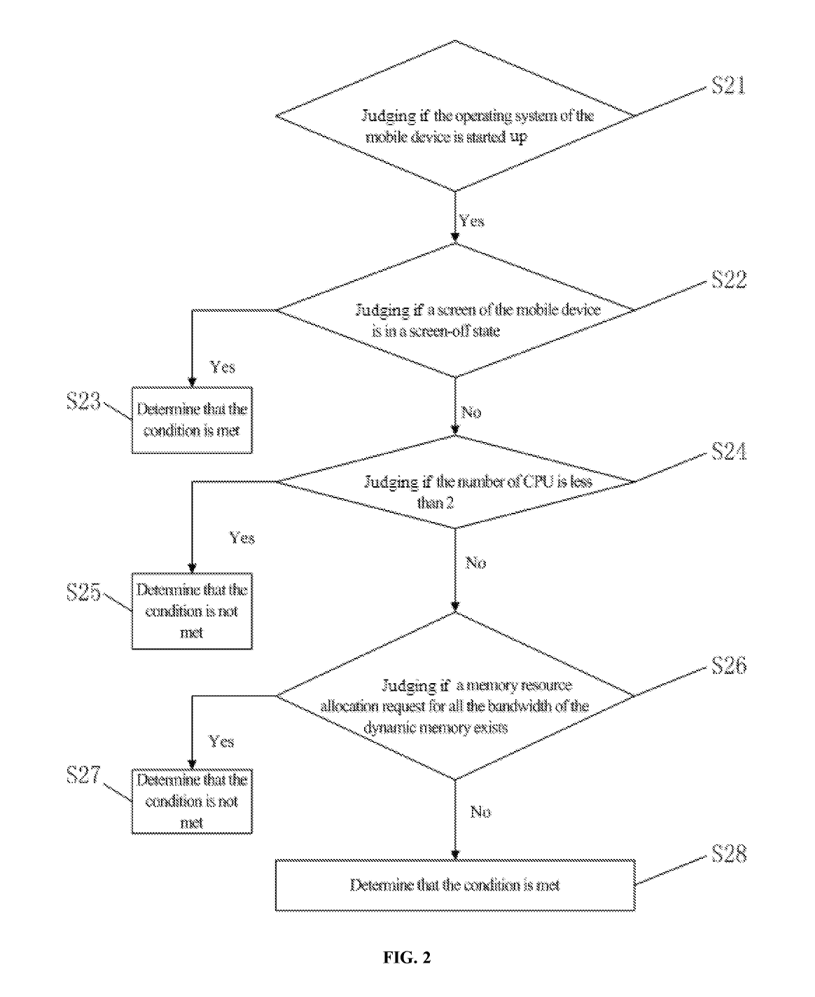

As a fifth variant form of the present embodiment, as shown in FIG. 2, the abovementioned step S2, namely the step of judging whether a condition that the bandwidth of the dynamic memory to be allocated is restricted to partial bandwidth is met or not, includes:

S21: judging whether startup of the operating system of the mobile device is completed or not;

S22: if startup of the operating system of the mobile device is completed, then judging whether a screen of the mobile device is in a screen-off state or not;

S23: if the screen of the mobile device is in the screen-off state, then determining that the condition is met; or

S24: otherwise, judging whether the number of CPU is less than 2 or not;

S25: if the number of CPU is less than 2, then determining that the condition is not met; or

S26: if the number of CPU is more than 2, then judging whether a memory resource allocation request for all the bandwidth of the dynamic memory exists or not; and

S27: if the memory resource allocation request exists, then determining that the condition is not met; or

S28: otherwise, determining that the condition is met.

In the present embodiment, firstly, if startup of the operating system of the mobile device is not completed, then the bandwidth of the dynamic memory to be allocated cannot be restricted, so as to increase the starting speed of the system. If startup of the operating system is completed, then the judgment needs to be performed according to the screen status of the mobile device, and if the screen is off, then the bandwidth of the dynamic memory to be allocated is restricted. However, if the screen is lit up, then the current number of CPU needs to be determined, and if the number is less than 2, then the bandwidth of the dynamic memory to be allocated is not restricted, or if the number is more than 2, whether the bandwidth of the dynamic memory to be allocated is restricted or not is determined according to the fact whether a memory resource allocation request for all the bandwidth exists or not.

### Embodiment 2

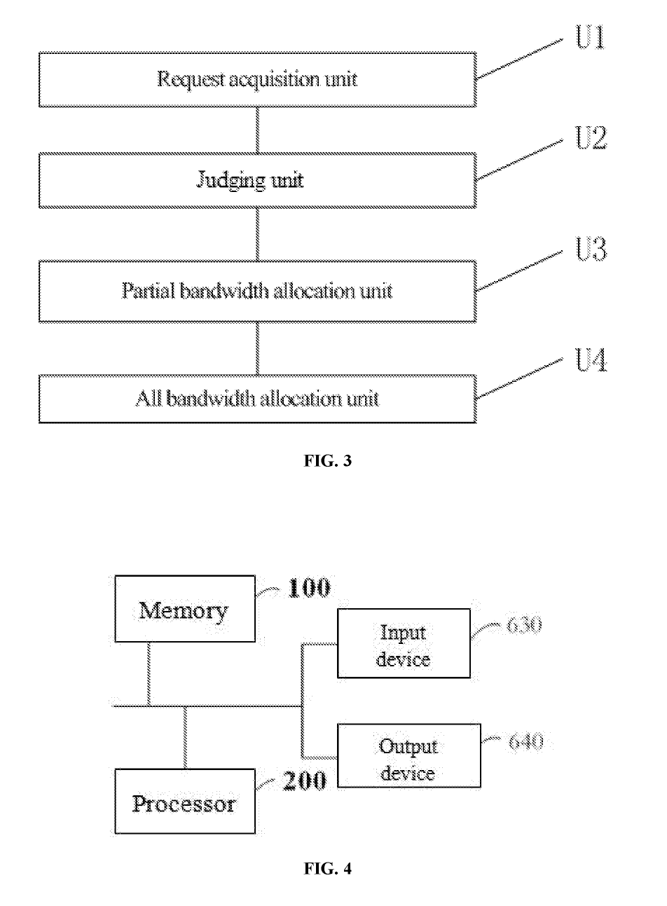

As shown in FIG. 3, the present embodiment provides an electronic device for allocating dynamic memory resources, including the following units:
a request acquisition unit U1, for acquiring a memory resource allocation request of an application;
a judging unit U2, for judging whether a condition that the bandwidth of the dynamic memory to be allocated is restricted to partial bandwidth is met or not;
a partial bandwidth allocation unit U3, for allocating partial bandwidth of the dynamic memory according to the memory resource allocation request, if the condition is met; and
an all bandwidth allocation unit U4, for allocating all the bandwidth of the dynamic memory to the application if the condition is not met.

The abovementioned electronic device allocates the memory resources according to the needs of a terminal device; and allocates all the bandwidth if the terminal device needs to allocate all the bandwidth, or otherwise, may allocate only a part of the bandwidth therein without occupying the remaining bandwidth resources. That is to say, the resources are saved only when the system does not need all the memory resources, so that not only the performance of a smart mobile terminal can be guaranteed, but also the endurance time of the smart mobile terminal can be prolonged.

Specifically, the judging unit U2 includes the following subunits:
a first judging subunit, for judging whether a memory resource allocation request for all the bandwidth of the dynamic memory exists or not;
a first determining subunit, for determining that the condition is not met if the memory resource allocation request for all the bandwidth of the dynamic memory exists; and
a second determining subunit, for determining that the condition is met if the memory resource allocation request for all the bandwidth of the dynamic memory does not exist.

As a first variant form of the present embodiment, the judging unit U2 includes the following subunits:
a second judging subunit, for determining whether a screen of the mobile device is in a screen-off state or not;
a third determining subunit, for determining that the condition is met if the screen is in the screen-off state, where the bandwidth of the dynamic memory to be allocated is restricted to one fourth when the screen is in the screen-off state; and
a fourth determining subunit, for determining that the condition is not met if the screen is lit up and the number of CPU is less than 2.

Moreover, the judging unit U2 also includes the following subunits:
a third judging subunit, for judging whether a memory resource allocation request for all the bandwidth of the dynamic memory exists or not if the number of CPU is more than 2;
a fifth determining subunit, for determining that the condition is not met if the memory resource allocation request for all the bandwidth of the dynamic memory exists; and
a sixth determining subunit, for determining that the condition is met if the memory resource allocation request for all the bandwidth of the dynamic memory does not exist.

As a second variant form of the present embodiment, the judging unit U2 includes the following subunits:
a fourth judging subunit, for judging whether an instruction to light up the screen exists or not when the screen of the mobile device is in a screen-off state; and
a seventh determining subunit, for determining that the condition is not met if the instruction to light up the screen exists.

The electronic device provided by the present embodiment can increase the speed of lighting up the screen.

As a third variant form of the present embodiment, the judging unit U2 includes the following subunits:
a fifth judging subunit, for judging whether startup of the operating system of the mobile device is started or not; and
an eighth determining subunit, for determining that the condition is not met if startup of the operating system of the mobile device is started.

The abovementioned electronic device uses all the bandwidth of the dynamic memory when the operating system is started up, thereby increasing the starting speed of the system, and improving the user experience.

As a fourth variant form of the present embodiment, the judging unit U2 includes the following subunits:
a sixth judging subunit, for judging whether startup of the operating system of the mobile device is completed or not;
a seventh judging subunit, for judging whether a memory resource allocation request for all the bandwidth of the dynamic memory exists or not if startup of the operating system is completed;
a ninth determining subunit, for determining that the condition is not met if the memory resource allocation request for all the bandwidth of the dynamic memory exists; and
a tenth determining subunit, for determining that the condition is met if the memory resource allocation request for all the bandwidth of the dynamic memory does not exist.

As a fifth variant form of the present embodiment, the judging unit U2 includes the following subunits:
a startup completion judging subunit, for judging whether startup of the operating system of the mobile device is completed or not;
a screen state judging subunit, for judging whether a screen of the mobile device is in a screen-off state or not if startup of the operating system is completed;
a first match condition determining subunit, for determining that the condition is met if the screen is in a screen-off state;
a CPU number judging subunit, for judging whether the number of

CPU is less than 2 or not, if the screen is in a screen-on state;
a first mismatch condition determining subunit, for determining that the condition is not met if the number of CPU is less than 2;
a request judging subunit, for judging whether a memory resource allocation request for all the bandwidth of the dynamic memory exists or not if the number of CPU is more than 2;
a second mismatch condition determining subunit, for determining that the condition is not met if a memory resource allocation request for all the bandwidth of the dynamic memory exists; and
a second match condition determining subunit, for determining that the condition is met if a memory resource allocation request for all the bandwidth of the dynamic memory does not exists.

### Embodiment 3

The embodiments of this disclosure provide a non-volatile computer storage medium storing computer executable instructions that, when executed by the electronic device, enable the electronic device to: acquire a memory resource allocation request of an application, judge whether a condition that the bandwidth of the dynamic memory to be allocated is restricted to partial bandwidth is met or not, and if the condition is met, then allocate partial bandwidth of the dynamic memory according to the memory resource allocation request, or otherwise, allocate all the bandwidth of the dynamic memory to the application.

As a preferred implementation, the step of judging whether the condition that the bandwidth of the dynamic memory to be allocated is restricted to partial bandwidth is met or not includes: judging whether a memory resource allocation request for all the bandwidth of the dynamic memory exists or not, and if the memory resource allocation request exists, then determining that the condition is not met; or otherwise, determining that the condition is met.

As a preferred implementation, the step of judging whether the condition that the bandwidth of the dynamic memory to be allocated is restricted to partial bandwidth is met or not includes: judging whether a screen of the mobile device is in a screen-off state or not; if the screen of the mobile device is in the screen-off state, then determining that the condition is met; or otherwise, judging whether the number of CPU is less than 2 or not; and if the number of CPU is less than 2, then determining that the condition is not met.

As a preferred implementation, the step of judging whether the condition that the bandwidth of the dynamic memory to be allocated is restricted to partial bandwidth is met or not also includes: judging whether a memory resource allocation request for all the bandwidth of the dynamic memory exists or not if the number of CPU is more than 2; and if the memory resource allocation request exists, then determining that the condition is not met; or otherwise, determining that the condition is met.

As a preferred implementation, when the screen is in the screen-off state, the bandwidth of the dynamic memory to be allocated is restricted to one fourth.

As a preferred implementation, the step of judging whether the condition that the bandwidth of the dynamic memory to be allocated is restricted to partial bandwidth is met or not includes: judging whether an instruction to light up the screen exists or not when the screen of the mobile device is in the screen-off state; and if the instruction exists, then determining that the condition is not met.

As a preferred implementation, the step of judging whether the condition that the bandwidth of the dynamic memory to be allocated is restricted to partial bandwidth is met or not includes: judging whether startup of an operating system of the mobile device is started or not; and if startup of the operating system of the mobile device is started, then determining that the condition is not met.

As a preferred implementation, the step of judging whether the condition that the bandwidth of the dynamic memory to be allocated is restricted to partial bandwidth is met or not includes: judging whether startup of the operating system of the mobile device is completed or not; if startup of the operating system of the mobile device is completed, then judging whether a memory resource allocation request for all the bandwidth of the dynamic memory exists or not; and if the memory resource allocation request exists, then determining that the condition is not met; or otherwise, determining that the condition is met.

As a preferred implementation, the step of judging whether the condition that the bandwidth of the dynamic memory to be allocated is restricted to partial bandwidth is met or not includes: judging whether startup of the operating system of the mobile device is completed or not; if startup of the operating system of the mobile device is completed, then judging whether a screen of the mobile device is in a screen-off state or not; if the screen of the mobile device is in the screen-off state, then determining that the condition is met; or otherwise, judging whether the number of CPU is less than 2 or not; if the number of CPU is less than 2, then determining that the condition is not met; or if the number of CPU is more than 2, judging whether a memory resource allocation request for all the bandwidth of the dynamic memory exists or not; and if the memory resource allocation request exists, then determining that the condition is not met; or otherwise, determining that the condition is met.

### Embodiment 4

FIG. 4 is a schematic diagram of a hardware structure of the electronic device for executing the method for allocating dynamic memory resources provided by the embodiments of this disclosure, and as shown in FIG. 4, the device includes one or more processors 200 and a memory 100, and one processor 200 is taken as an example in FIG. 4; and the device for executing the method for allocating dynamic memory resources may also include an input device 630 and an output device 640.

The processor 200, the memory 100, the input device 630 and the output device 640 may be connected by virtue of a bus or in other ways, and bus connection is taken as an example in FIG. 4.

The memory 100, as a non-volatile computer readable storage medium, may be used for storing non-volatile software programs, non-volatile computer executable programs and modules, for example, program instructions/modules (e.g., a request acquisition unit U1, a judging unit U2, a partial bandwidth allocation unit U3 and an all bandwidth allocation unit U4 shown in FIG. 3) corresponding to the method for allocating dynamic memory resources in the embodiments of this disclosure. The processor 200 runs the non-volatile software programs, instructions and modules stored in the memory 100 so as to execute various functional applications and data processing of a server, thereby implementing the method for allocating dynamic memory resources in the abovementioned embodiments of the method.

The memory 100 may include a program storage area and a data storage area, where the program storage area may store an operating system and applications for at least one functions; and the data storage area may store data and the like created according to the use of a device for allocating dynamic memory resources. Moreover, the memory 100 may include a high-speed random access memory, and may also include a non-volatile memory, for example, at least one disk storage device, a flash memory, or other non-volatile solid storage devices. In some embodiments, the memory 100 optionally includes memories that are set remotely relative to the processor 200, and these remote memories may be connected to the device for allocating dynamic memory resources through a network. An example of the network includes, but is not limited to, internet, intranet, LAN, mobile communication network, and the combinations thereof

The input device 630 may receive input digit or character information, and generate a key signal input related to the user configuration and function control of the device for allocating dynamic memory resources. The output device 640 may include display devices such as a display screen.

The one or more modules are stored in the memory 100, and when executed by the one or more processors 200, perform the method for allocating dynamic memory resources in any one of the abovementioned embodiments of the method.

The abovementioned product can execute the method provided by the embodiments of this disclosure and has corresponding functional modules for executing the method and beneficial effects. For more technical details of this embodiment, please refer to the method provided by the embodiments of this disclosure.

The electronic device of the embodiments of this disclosure exists in many forms, including but not limited to the following devices:

(1) Mobile communication devices: the characteristic of such devices is that they have a mobile communication function with a main goal of enabling voice and data communication. Such terminals include: smart phones (such as iPhone), multimedia phones, feature phones, low-end phones, etc.

(2) Ultra-mobile personal computer devices: such devices belong to the category of personal computers, have computing and processing functions, and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, intelligent toys, and portable vehicle navigation devices.

(4) Servers: devices providing computing services. The structure of a server includes a processor, a hard disk, an internal memory, an electronic device bus, etc. A server has architecture similar to that of a general purpose computer, but in order to provide highly reliable services, the server has higher requirements in aspects of processing capability, stability, reliability, security, expandability, manageability, etc.

(5) Other electronic devices having data interaction function.

The abovementioned device embodiments are only illustrative, where the units described as separate parts may be or may not be physically separated, the components shown as units may be or may not be physical units, i.e. may be located in one place, or may be distributed at multiple network units. According to actual needs, part of or all of the modules therein may be selected to realize the objectives of the technical scheme of the embodiment.

By abovementioned descriptions of the embodiments, those skilled in the art can clearly understand that the various embodiments may be implemented by means of software and a general hardware platform, or just by means of hardware. Based on such understanding, the abovementioned technical scheme in essence, or the part thereof making contribution to a related art, may be embodied in the form of a software product, and such computer software product may be stored in a computer readable storage medium such as an ROM/RAM, a magnetic disk or an optical disk, etc., and may include a plurality of instructions to enable a computer device (which may be a personal computer, a server, or a network device) to execute the methods described in the various embodiments or in some parts thereof.

Finally, it should be noted that: the abovementioned embodiments are merely illustrated for describing rather than limiting the technical scheme of this disclosure; although detailed description of this disclosure is given with reference to the abovementioned embodiments, those skilled in the art should understand that they still can modify the technical scheme recorded in the abovementioned various embodiments or replace part of the technical features therein with equivalents; and these modifications or replacements would not cause the essence of the corresponding technical scheme to depart from the spirit and scope of the technical scheme of the various embodiments of this disclosure.

What is claimed is:

1. A method for allocating dynamic memory resources, comprising the following steps:
acquiring a memory resource allocation request of an application;
judging whether a condition that the bandwidth of the dynamic memory to be allocated is restricted to partial bandwidth is met or not; and
if the condition is met, then allocating partial bandwidth of the dynamic memory according to the memory resource allocation request; or
otherwise, allocating all the bandwidth of the dynamic memory to the application.

2. The method according to claim 1, wherein the step of judging whether the condition that the bandwidth of the dynamic memory to be allocated is restricted to partial bandwidth is met or not comprises:
judging whether a memory resource allocation request for all the bandwidth of the dynamic memory exists or not; and
if the memory resource allocation request exists, then determining that the condition is not met; or
otherwise, determining that the condition is met.

3. The method according to claim 1, wherein the step of judging whether the condition that the bandwidth of the dynamic memory to be allocated is restricted to partial bandwidth is met or not comprises:
judging whether a screen of the mobile device is in a screen-off state or not;
if the screen is in the screen-off state, then determining that the condition is met; or otherwise, judging whether the number of CPU is less than 2 or not; and if the number of CPU is less than 2, then determining that the condition is not met.

4. The method according to claim 3, wherein the step of judging whether the condition that the bandwidth of the dynamic memory to be allocated is restricted to partial bandwidth is met or not also comprises:
judging whether a memory resource allocation request for all the bandwidth of the dynamic memory exists or not, if the number of CPU is more than 2; and
if the memory resource allocation request exists, then determining that the condition is not met; or otherwise, determining that the condition is met.

5. The method according to claim 3, wherein when the screen is in the screen-off state, the bandwidth of the dynamic memory to be allocated is restricted to one fourth.

6. The method according to claim 1, wherein the step of judging whether the condition that the bandwidth of the dynamic memory to be allocated is restricted to partial bandwidth is met or not comprises:
judging whether an instruction to light up the screen exists or not when the screen of the mobile device is in the screen-off state; and
if the instruction exists, then determining that the condition is not met.

7. The method according to claim 1, wherein the step of judging whether the condition that the bandwidth of the dynamic memory to be allocated is restricted to partial bandwidth is met or not comprises:
judging whether startup of an operating system of the mobile device is started or not; and
if startup of the operating system of the mobile device is started, then determining that the condition is not met.

8. The method according to claim 1, wherein the step of judging whether the condition that the bandwidth of the dynamic memory to be allocated is restricted to partial bandwidth is met or not comprises:
judging whether startup of the operating system of the mobile device is completed or not;
if startup of the operating system of the mobile device is completed, then judging whether a memory resource allocation request for all the bandwidth of the dynamic memory exists or not; and
if memory resource allocation request exists, then determining that the condition is not met; or otherwise, determining that the condition is met.

9. The method according to claim 1, wherein the step of judging whether the condition that the bandwidth of the dynamic memory to be allocated is restricted to partial bandwidth is met or not comprises:
judging whether startup of the operating system of the mobile device is completed or not;
if startup of the operating system of the mobile device is completed, then determining whether a screen of the mobile device is in a screen-off state or not;
if the screen of the mobile device is in the screen-off state, then determining that the condition is met; or
otherwise, judging whether the number of CPU is less than 2 or not;
if the number of CPU is less than 2, then determining that the condition is not met; or
if the number of CPU is more than 2, then judging whether a memory resource allocation request for all the bandwidth of the dynamic memory exists or not; and
if the memory resource allocation request exists, then determining that the condition is not met; or otherwise, determining that the condition is met.

10. An electronic device, comprising at least one processor, and a memory in communication connection with the at least one processor, wherein the memory stores instructions that can be executed by the at least one processor, and the instructions are executed by the at least one processor to enable the at least one processor to:
acquire a memory resource allocation request of an application;
judge whether a condition that the bandwidth of the dynamic memory to be allocated is restricted to partial bandwidth is met or not; and
allocate partial bandwidth of the dynamic memory according to the memory resource allocation request if the condition is met; or allocate all the bandwidth of the dynamic memory to the application if the condition is not met.

11. The electronic device according to claim 10, wherein the step of judging whether a condition that the bandwidth of the dynamic memory to be allocated is restricted to partial bandwidth is met or not comprises:
judging whether a memory resource allocation request for all the bandwidth of the dynamic memory exists or not; and
if the memory resource allocation request exists, then determining that the condition is not met; or
otherwise, determining that the condition is met.

12. The electronic device according to claim 10, wherein the step of judging whether the condition that the bandwidth of the dynamic memory to be allocated is restricted to partial bandwidth is met or not comprises:
judging whether a screen of the mobile device is in a screen-off state or not;
if the screen of the mobile device is in the screen-off state, then determining that the condition is met; or
otherwise, judging whether the number of CPU is less than 2 or not; and
if the number of CPU is less than 2, then determining that the condition is not met.

13. The electronic device according to claim 12, wherein the step of judging whether the condition that the bandwidth of the dynamic memory to be allocated is restricted to partial bandwidth is met or not comprises:
if the number of CPU is more than 2, then judging whether a memory resource allocation request for all the bandwidth of the dynamic memory exists or not; and
if the memory resource allocation request exists, then determining that the condition is not met; or
otherwise, determining that the condition is met.

14. The electronic device according to claim 12, wherein when the screen is in the screen-off state, the bandwidth of the dynamic memory to be allocated is restricted to one fourth.

15. A non-volatile computer storage medium storing computer executable instructions, wherein the computer executable instructions, when executed by the electronic device, enable the electronic device to:
acquire a memory resource allocation request of an application;
judge whether a condition that the bandwidth of the dynamic memory to be allocated is restricted to partial bandwidth is met or not; and
if the condition is met, then allocate partial bandwidth of the dynamic memory according to the memory resource allocation request; or
otherwise, allocate all the bandwidth of the dynamic memory to the application.

16. The non-volatile computer storage medium according to claim 15, wherein the step of judging whether the condition that the bandwidth of the dynamic memory to be allocated is restricted to partial bandwidth is met or not comprises:
judging whether a memory resource allocation request for all the bandwidth of the dynamic memory exists or not; and
if the memory resource allocation request exists, then determining that the condition is not met; or
otherwise, determining that the condition is met.

17. The non-volatile computer storage medium according to claim 16, wherein the step of judging whether the condition that the bandwidth of the dynamic memory to be allocated is restricted to partial bandwidth is met or not comprises:
judging whether a screen of the mobile device is in a screen-off state or not;
if the screen of the mobile device is in the screen-off state, then determining that the condition is met; or
otherwise, judging whether the number of CPU is less than 2 or not; and
if the number of CPU is less than 2, then determining that the condition is not met.

18. The non-volatile computer storage medium according to claim 17, wherein the step of judging whether the condition that the bandwidth of the dynamic memory to be allocated is restricted to partial bandwidth is met or not further comprises:
if the number of CPU is more than 2, then judging whether a memory resource allocation request for all the bandwidth of the dynamic memory exists or not; and
if the memory resource allocation request exists, then determining that the condition is not met; or
otherwise, determining that the condition is met.

19. The non-volatile computer storage medium according to claim 17, wherein when the screen is in the screen-off state, the bandwidth of the dynamic memory to be allocated is restricted to one fourth.

20. The non-volatile computer storage medium according to claim 15, wherein the step of judging whether the condition that the bandwidth of the dynamic memory to be allocated is restricted to partial bandwidth is met or not comprises:
judging whether an instruction to light up the screen exists or not when the screen of the mobile device is in the screen-off state; and
if the instruction exists, then determining that the condition is not met.
